(19) United States
(12) Patent Application Publication
(10) Pub. No.: US 2024/0220349 A1
(43) Pub. Date: Jul. 4, 2024

(54) NETWORK LEVEL AUTO-HEALING BASED ON TROUBLESHOOTING/RESOLUTION METHOD OF PROCEDURES AND KNOWLEDGE-BASED ARTIFICIAL INTELLIGENCE

(71) Applicant: RAKUTEN MOBILE, INC., Tokyo (JP)

(72) Inventor: Moataz RADY, Tokyo (JP)

(73) Assignee: RAKUTEN MOBILE, INC., Tokyo (JP)

(21) Appl. No.: 17/923,806

(22) PCT Filed: Sep. 7, 2022
(86) PCT No.: PCT/US2022/042705

§ 371 Date: Mar. 14, 2024

(51) Int. Cl. G06F 11/07; G06N 5/022

(52) U.S. Cl. CPC G06F 11/079; G06F 11/0709; G06F 11/0793; G06N 5/022

(57) ABSTRACT

A method of network auto-healing performed by at least one processor includes receiving an indication that an alarm corresponding to an error in a network is triggered, determining whether an existing root cause analysis (RCA) corresponds to the error, based on determining that an existing RCA does not correspond to the error, generating, by a knowledge-based artificial intelligence (AI) model, a first RCA for resolving the error, and identifying a first resolution to the error based on the first RCA.

### BACKGROUND

### 1. Field

Apparatuses and methods consistent with example embodiments of the present disclosure relate to network auto-healing.

### 2. Description of Related Art

A troubleshooting method of procedure (T-MOP) may auto-identify a network level root cause analysis (RCA) when an error/issue occurs based on a predetermined set of steps. A related art resolution method of procedure (R-MOP) may identify automated resolution steps for a specific error/issue. However, there is no coordination between the T-MOP and the R-MOP. Furthermore, auto-healing, as well as the T-MOP and R-MOP, are not performed based on an intelligence model.

### SUMMARY

According to embodiments, systems and methods are provided for network auto-healing based on a knowledge based artificial intelligence (AI) model.

According to an aspect of the disclosure, a method of network auto-healing performed by at least one processor may include receiving an indication that an alarm corresponding to an error in a network is triggered, determining whether an existing root cause analysis (RCA) corresponds to the error, based on determining that an existing RCA does not correspond to the error, generating, by a knowledge-based artificial intelligence (AI) model, a first RCA for resolving the error, and identifying a first resolution to the error based on the first RCA.

According to an aspect of the disclosure, a system for network auto-healing may include at least one memory storing instructions, and at least one processor configured to execute the instructions to receive an indication that an alarm corresponding to an error in a network is triggered, determine whether an existing RCA corresponds to the error, based on determining that an existing RCA does not correspond to the error, generate, by a knowledge-based AI model, a first RCA for resolving the error, and identify a first resolution to the error based on the first RCA.

According to an aspect of the disclosure, a non-transitory computer-readable storage medium may store instructions that, when executed by at least one processor, cause the at least one processor to receive an indication that an alarm corresponding to an error in a network is triggered, determine whether an existing RCA corresponds to the error, based on determining that an existing RCA does not correspond to the error, generate, by a knowledge-based AI model, a first RCA for resolving the error, and identify a first resolution to the error based on the first RCA.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of an example environment in which systems and/or methods, described herein, may be implemented;

FIG. 2 is a diagram of example components of a device according to an embodiment;

FIGS. 3, 4 and 5 are flowcharts of a process for network auto-healing, according to an embodiment; and

FIG. 6 is a flowchart of a method for network auto-healing, according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

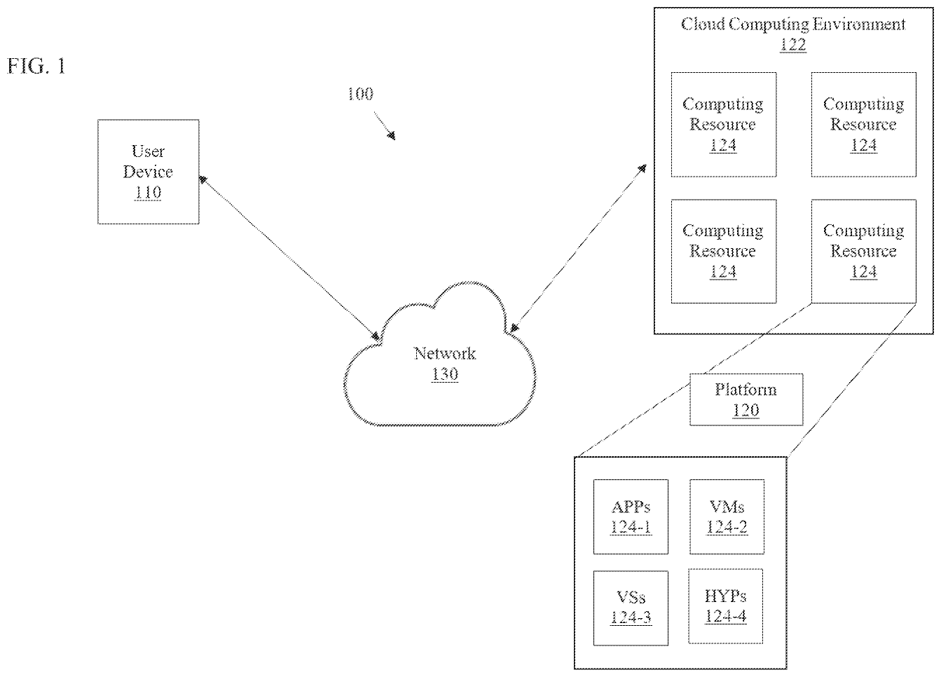

FIG. 1 is a diagram of an example environment 100 in which systems and/or methods, described herein, may be implemented. As shown in FIG. 1, environment 100 may include a user device 110, a platform 120, and a network 130. Devices of environment 100 may interconnect via wired connections, wireless connections, or a combination of wired and wireless connections. In embodiments, any of the functions and operations described with reference to FIG. 1 above may be performed by any combination of elements illustrated in FIG. 1.

User device 110 includes one or more devices capable of receiving, generating, storing, processing, and/or providing information associated with platform 120. For example, user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 110 may receive information from and/or transmit information to platform 120.

Platform 120 includes one or more devices capable of receiving, generating,

storing, processing, and/or providing information. In some implementations, platform 120 may include a cloud server or a group of cloud servers. In some implementations, platform 120 may be designed to be modular such that certain software components may be swapped in or out depending on a particular need. As such, platform 120 may be easily and/or quickly reconfigured for different uses.

In some implementations, as shown, platform 120 may be hosted in cloud computing environment 122. Notably, while implementations described herein describe platform 120 as being hosted in cloud computing environment 122, in some implementations, platform 120 may not be cloud-based (i.e., may be implemented outside of a cloud computing environment) or may be partially cloud-based.

Cloud computing environment 122 includes an environment that hosts platform 120. Cloud computing environment 122 may provide computation, software, data access, storage, etc. services that do not require end-user (e.g., user device 110) knowledge of a physical location and configuration of system(s) and/or device(s) that hosts platform 120. As shown, cloud computing environment 122 may include a group of computing resources 124 (referred to collectively as “computing resources 124” and individually as “computing resource 124”).

Computing resource 124 includes one or more personal computers, a cluster of computing devices, workstation computers, server devices, or other types of computation and/or communication devices. In some implementations, computing resource 124 may host platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

As further shown in FIG. 1, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

Application 124-1 includes one or more software applications that may be provided to or accessed by user device 110. Application 124-1 may eliminate a need to install and execute the software applications on user device 110. For example, application 124-1 may include software associated with platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system (“OS”). A process virtual machine may execute a single program, and may support a single process. In some implementations, virtual machine 124-2 may execute on behalf of a user (e.g., user device 110), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems, and may manage the execution of the guest operating systems. Multiple instances of a variety of operating systems may share virtualized hardware resources.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

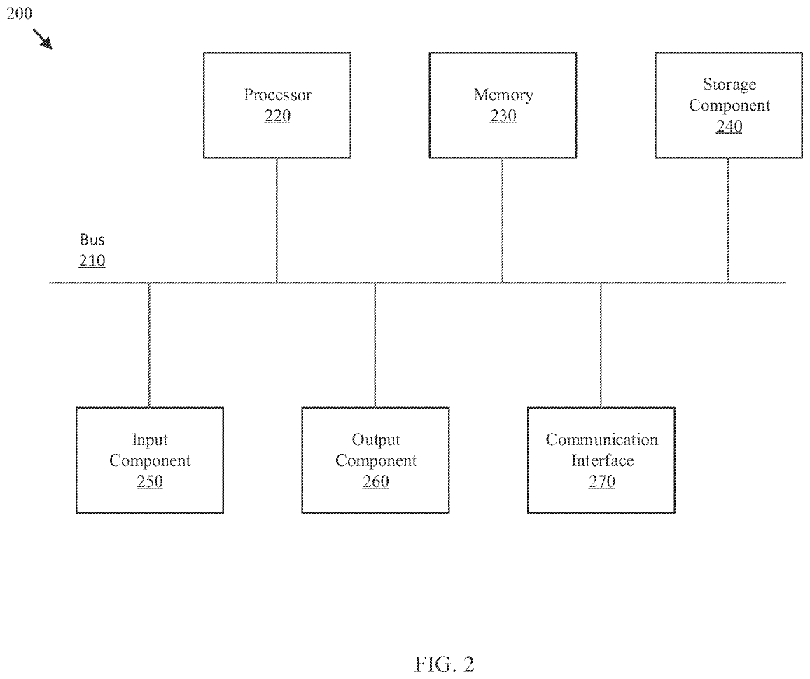

FIG. 2 is a diagram of example components of a device 200. Device 200 may correspond to user device 110 and/or platform 120. As shown in FIG. 2, device 200 may include a bus 210, a processor 220, a memory 230, a storage component 240, an input component 250, an output component 260, and a communication interface 270.

Bus 210 includes a component that permits communication among the components of device 200. Processor 220 may be implemented in hardware, firmware, or a combination of hardware and software. Processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 250 includes a component that permits device 200 to receive information, such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). Output component 260 includes a component that provides output information from device 200 (e.g., a display, a speaker, and/or one or more light-emitting diodes (LEDs)).

Communication interface 270 includes a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein. Device 200 may perform these processes in response to processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

A troubleshooting method of procedure (T-MOP) may auto-identify a network level root cause analysis (RCA) when an error/issue (hereinafter, referred to as an “error”) occurs. A resolution method of procedure (R-MOP) may identify automated resolution steps for a specific error. With the implementation of a knowledge-based artificial intelligence (AI) model, the provided systems, methods and devices may identify new or previously unidentified RCAs and their corresponding resolution MOP. The system may include a loop protection mechanism to avoid looping in the knowledge-based AI model, such that new factors may be introduced to assist the knowledge-based AI model on tracking new and different decisions.

Provided are systems, methods and devices for network auto-healing. The network auto-healing may be implemented by at least one processor, and may include receiving an indication that an alarm corresponding to an error in a network is triggered, determining whether an existing RCA corresponds to the error, based on determining that an existing RCA does not correspond to the error, generating, by a knowledge-based AI model, an RCA for resolving the error, and identifying a first resolution to the error based on the RCA. The system may also, in response to an RCA failure or a resolution failure, generate a new resolution to resolve the failure of the existing RCA or a previously determined resolution. The systems, methods and devices provide network stability by implementing faster recovery processes, improved network intelligence by reducing manual work, increased operations performance, and cost efficient operations.

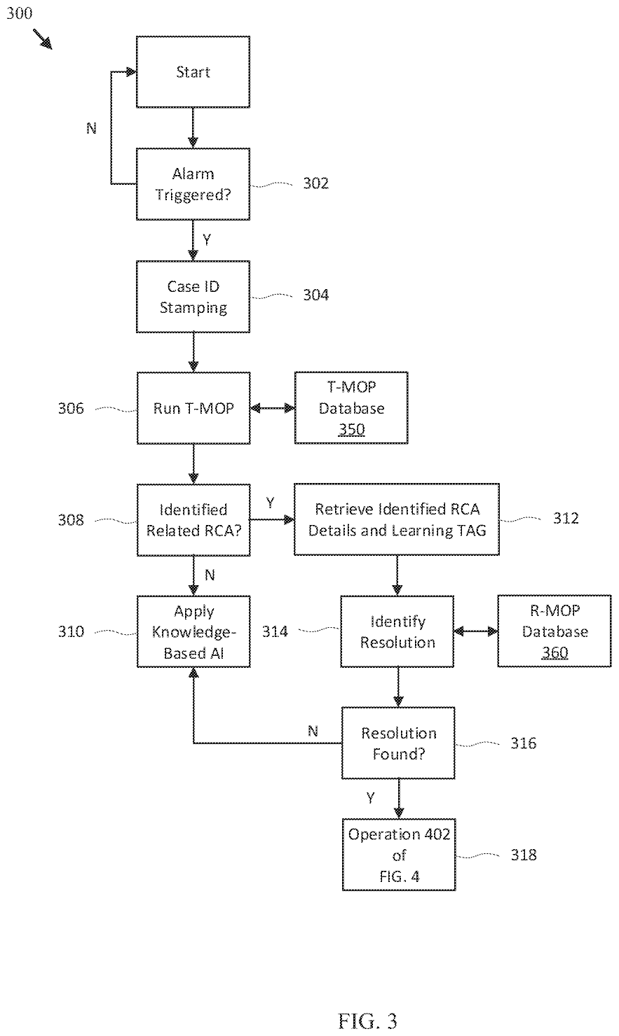

FIGS. 3, 4 and 5 are flowcharts of a process for network auto-healing, according to an embodiment. In operation 302 of process 300, the system may determine whether an alarm is triggered. The alarm may correspond to an error in the network. The error may include low network performance, abnormal node behavior in hardware, an increase in the number of malfunctions in the network, etc. If no alarm is triggered, the system may restart the process 300. If an alarm is triggered, in operation 304, the system may receive an indication that the alarm is triggered and may perform a case identifier (ID) stamping (i.e., providing an identifier to the case that corresponds to the triggered alarm). In operation 306, the system may run a T-MOP. The T-MOP may be run based on information retrieved from a T-MOP database 350. In operation 308, the system identify whether an existing RCA related to the error is available. That is, if the system has previously handled the error at hand, or if the system is previously loaded with an RCA that corresponds to the error, then the system may identify the RCA. If the system does not identify an existing RCA that corresponds to the error, then, in operation 310, the system may apply a knowledge-based AI model.

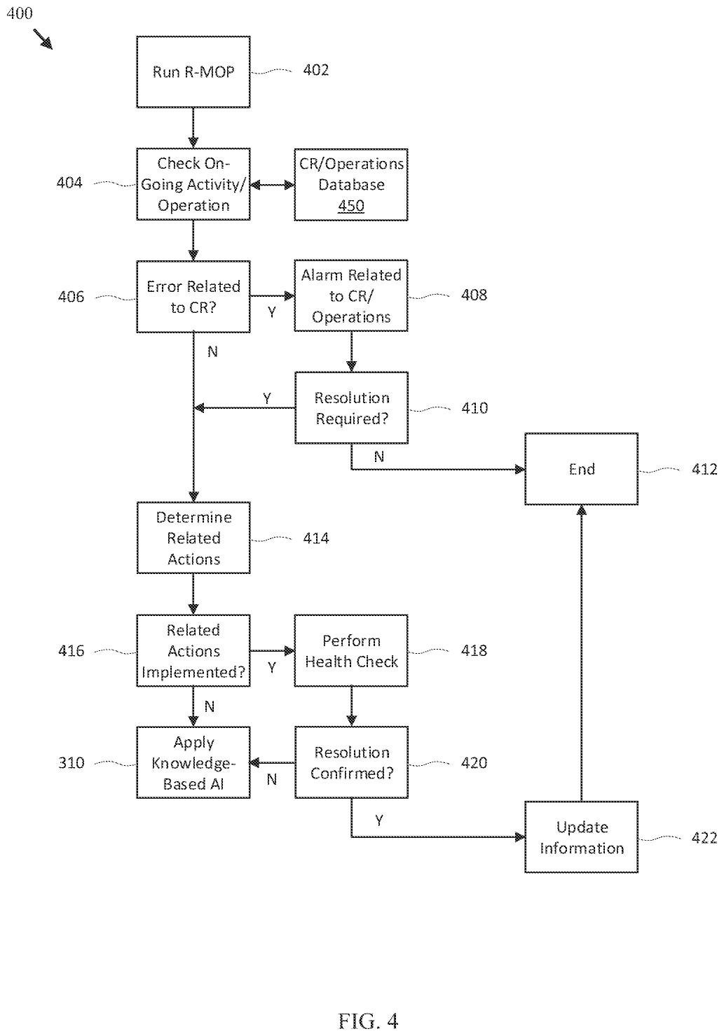

If the system identifies an existing RCA that corresponds to the error, then, in operation 312, the system may retrieve the identified RCA details and a learning TAG. The learning TAG may refer to a tagging per case indicating a system confidence about an RCA and a related resolution. The more successful an RCA and resolution may be reflected as an increase of the learning TAG. A higher learning TAG may reflect higher case confidence for both the RCA and the resolution In operation 314, the system may identify a resolution to the error. The system may retrieve information from an R-MOP database 360 to identify a resolution to the error. In operation 316, if a resolution is not found, then the system may proceed to operation 310 and apply the knowledge-based AI model. In operation 316, if a resolution is found, the system may proceed to operation 402 of FIG. 4.

In operation 402 in the process 400, the system may run the R-MOP. In operation 404, the system may check on-going activity or operations in the network. The system may check on-going activity by retrieving information from a change request (CR)/operations database 450. In operation 406, the system may determine whether the error is related to CR/operations. If the system determines that error is related to CR/operations, in operation 408, then, in operation 410, the system determines whether a resolution to the error is required. If no resolution is required, then the system may end the process at operation 412.

If the system determines that a resolution is required, or if the system determines that the error is not related to CR/operations in operation 406, then, in operation 414, the system may determine related actions to implement to resolve the error. That is, in the previous operations, the system identified the RCA from the T-MOP and obtained the related resolution from the R-MOP (or from the knowledge-based AI). Thus, the system may determine actions based on the previous operations. The actions may include, node RST, configuration change, node isolation if redundancy is available, etc. For example, the system may implement a configuration look up for change, including configuration changes such as a timer change, enablement of related features, etc., the system may determine an action need for CR (i.e., the system may create an automated CR for the changes), the system may identify abnormal node behavior and configure the corresponding physical hardware for isolation, etc. Some CRs may require management approval based on the CR being critical, while other CRs may be implemented to perform the changes directly.

In operation 416, the system may determine whether the related actions are implemented. If the related actions are not implemented, then in operation 310, the system may apply the knowledge-based AI model. If the related actions are implemented, then in operation 418, the system may perform a health check in the levels of the network after the actions are implemented. In operation 420, the system may confirm whether the resolution resolves the error. If the resolution does not resolve the error, then in operation 310, the system may apply the knowledge based AI network. If the resolution resolves the error, in operation 422, the system may update information for the network accordingly, such as updating the learning TAG for the databases 350, 360 and 450, as well as the knowledge-based AI model. Then, the system may end the process at operation 412.

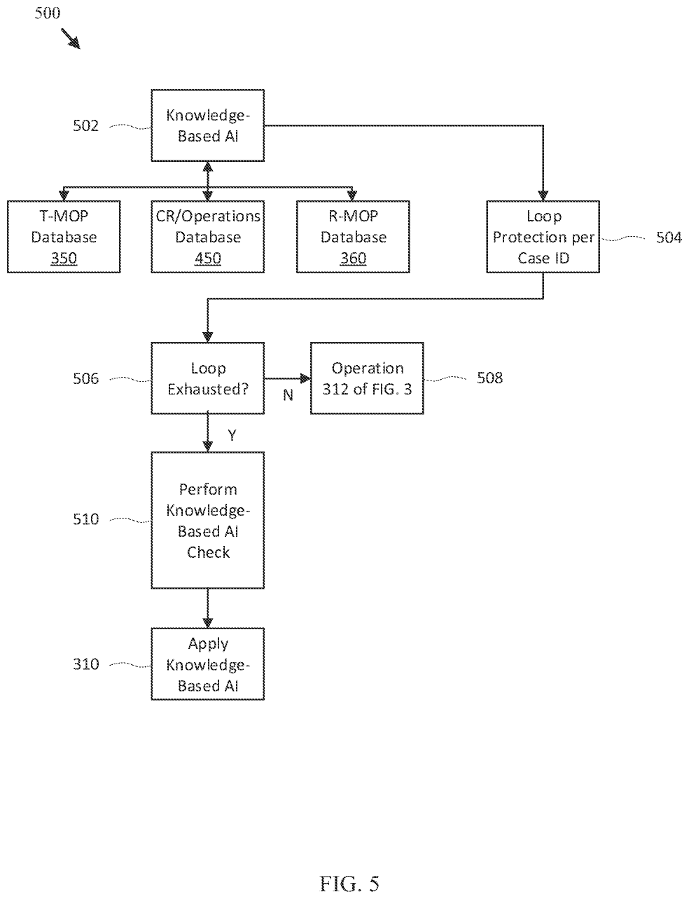

Referring to FIG. 5, the process 500 may represent the operation 310 of applying the knowledge-based AI model 502. The knowledge-based AI model 502 may be configured to generate an RCA and/or a resolution for the network to resolve the error when no other RCA is identified to resolve the error, an identified RCA does not resolve the error, a resolution determined based on the RCA or based on a failed resolution does not resolve the error, etc. The knowledge-based AI model 502 may generate an RCA and/or resolution based on information from the T-MOP database 350, the R-MOP database 360, and or the CR/Operations database 450.

When the knowledge-based AI model 502 is implemented/applied to generate an RCA/resolution as is described above, in operation 504, the system may generate a loop protection for the case ID. That is, the system may increment a loop number counter corresponding to the case ID. The loop may refer to a sequence of events that occurs in the network that causes the process to apply the knowledge-based AI model 502 for generating an RCA, generating a resolution based on an existing RCA, generating a new RCA, generating a resolution based on a failed previous resolution, etc. In operation 506, the system may determine whether the loops for the case ID are exhausted. That is, the system may compare the loop counter number with a predetermined number of loops, the predetermined number of loops being based on the case ID (e.g., a case type may be used to determine how many loops are permitted), based on a system configuration, etc. If the loop counter number does not exceed the predetermined number of loops, then the system may determine that the number of loops are not exhausted, and, in operation 508, the system may redirect the process to operation 312 of FIG. 3.

If the loop counter number exceeds the predetermined number of loops (and/or is equal to the predetermined number of loops according to some embodiments), then the system determines that the number of loops are exhausted, and in operation 510, the system may perform a check or series of checks on the knowledge-based AI model 502. For example, the system may check a mind map of the knowledge-based AI model 502, the system may check the state machine flowchart, the system may identify abnormalities in the knowledge-based AI model 502, the system may detect a problematic scenario of the network, the system may create a new mind map for the knowledge-based AI model 502, the system may create a new state machine flowchart for the knowledge-based AI model 502, the system may identify an R-MOP for the knowledge-based AI model 502, and the system may update a learning TAG value for the knowledge-based AI model 502.

In some embodiments, any RCA or resolution may be matched by a sequence of flowchart checks, and in the case of a failure, a specific check or matching point in the flowchart (i.e., when the case is not identified). The system may mark the breaking point, match the successful points, search for differences about the breaking point, identify the differences and add it as a checkpoint in the new flow, for a new case to be matched. Then, the system may reapply the knowledge-based AI model 502, as in operation 310 (e.g., repeating the overall process for at least operation 310).

In this way, by implementing the loop counter and loop threshold (e.g., the predetermined number of loops), the system may be prevented from entering an infinite loop of attempting to generate an RCA for resolving the error, and the knowledge-based AI model 502 may be continually updated for successful identification and/or generation of RCAs for resolving the network issues.

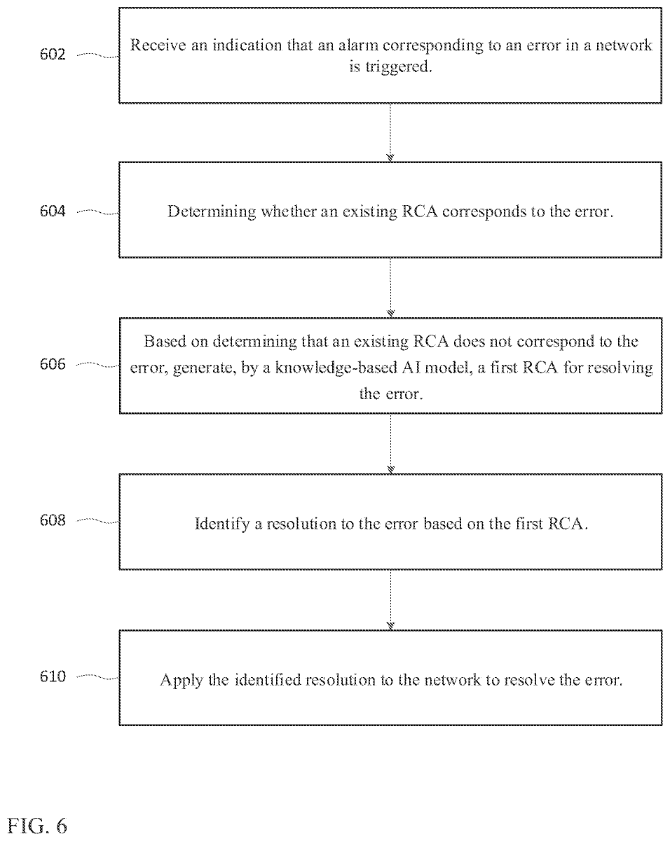

FIG. 6 is a flowchart of a method of network auto-healing, according to an embodiment. In operation 602, the system may receive an indication that an alarm corresponding to an error in a network is triggered. In operation 604, the system may determine whether an existing RCA corresponds to the error. In operation 606, the system may, based on determining that an existing RCA does not correspond to the error, generate, by a knowledge-based AI model, a first RCA for resolving the error. In operation 608, the system may identify a first resolution to the error based on the first RCA. In operation 610, the system may apply the identified resolution to the network to resolve the error.

In embodiments, any one of the operations or processes of FIGS. 3-6 may be implemented by or using any one of the elements illustrated in FIGS. 1 and 2.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method of network auto-healing performed by at least one processor, the method comprising:
receiving an indication that an alarm corresponding to an error in a network is triggered;
determining whether an existing root cause analysis (RCA) corresponds to the error;
based on determining that an existing RCA does not correspond to the error, generating, by a knowledge-based artificial intelligence (AI) model, a first RCA for resolving the error; and
identifying a first resolution to the error based on the first RCA.

2. The method of claim 1, wherein the knowledge-based AI model is configured to generate the first RCA by retrieving information from at least one of a troubleshooting methods of procedure (T-MOP) database, a resolution method of procedure (R-MOP) database, and a change request (CR) database.

3. The method of claim 1, further comprising, based on determining that an existing RCA does correspond to the error:
identifying an existing resolution to the error based on the existing RCA; and
applying the existing resolution to the network to resolve the error.

4. The method of claim 3, further comprising, based on the existing resolution not resolving the error, generating, by the knowledge-based AI model and using at least information regarding a failure of the existing resolution, a new resolution for resolving the error.

5. The method of claim 1, further comprising:
determining whether a number of loops for the knowledge-based AI model exceeds a predetermined loop threshold; and
based on the number of loops not exceeding the predetermined loop threshold:
performing the identifying; and
applying the first resolution to the network to resolve the error.

6. The method of claim 1, further comprising:
determining whether a number of loops for the knowledge-based AI in generating RCAs exceeds a predetermined loop threshold; and
based on the number of loops exceeding the predetermined loop threshold:
identifying at least one abnormality with the knowledge-based AI model; and
updating the knowledge-based AI model based on the identified abnormality.

7. The method of claim 1, further comprising determining whether the error corresponds to a change request (CR); and
based on determining that the error corresponds to the CR, refraining from applying the first resolution to the network.

8. A system for network auto-healing, the system comprising:
at least one memory storing instructions; and
at least one processor configured to execute the instructions to:
receive an indication that an alarm corresponding to an error in a network is triggered;
determine whether an existing root cause analysis (RCA) corresponds to the error;
based on determining that an existing RCA does not correspond to the error, generate, by a knowledge-based artificial intelligence (AI) model, a first RCA for resolving the error; and
identify a first resolution to the error based on the first RCA.

9. The system of claim 8, wherein the knowledge-based AI model is configured to generate the first RCA by retrieving information from at least one of a troubleshooting systems of procedure (T-MOP) database, a resolution system of procedure (R-MOP) database, and a change request (CR) database.

10. The system of claim 8, wherein the at least one processor is further configured to, based on determining that an existing RCA does correspond to the error:
identify an existing resolution to the error based on the existing RCA; and
apply the existing resolution to the network to resolve the error.

11. The system of claim 10, wherein the at least one processor is further configured to, based on the existing resolution not resolving the error, generate, by the knowledge-based AI model and using at least information regarding a failure of the existing resolution, a new resolution for resolving the error.

12. The system of claim 8, wherein the at least one processor is further configured to:
determine whether a number of loops for the knowledge-based AI model exceeds a predetermined loop threshold; and
based on the number of loops not exceeding the predetermined loop threshold:
perform the identifying; and
apply the first resolution to the network to resolve the error.

13. The system of claim 8, wherein the at least one processor is further configured to:
determine whether a number of loops for the knowledge-based AI in generating RCAs exceeds a predetermined loop threshold; and
based on the number of loops exceeding the predetermined loop threshold:
identify at least one abnormality with the knowledge-based AI model; and
update the knowledge-based AI model based on the identified abnormality.

14. The system of claim 8, wherein the at least one processor is further configured to determine whether the error corresponds to a change request (CR); and
based on determining that the error corresponds to the CR, refrain from applying the first resolution to the network.

15. A non-transitory computer-readable storage medium storing instructions that, when executed by at least one processor, cause the at least one processor to:
receive an indication that an alarm corresponding to an error in a network is triggered;
determine whether an existing root cause analysis (RCA) corresponds to the error;
based on determining that an existing RCA does not correspond to the error, generate, by a knowledge-based artificial intelligence (AI) model, a first RCA for resolving the error; and
identify a first resolution to the error based on the first RCA.

16. The storage medium of claim 15, wherein the knowledge-based Al model is configured to generate the first RCA by retrieving information from at least one of a troubleshooting systems of procedure (T-MOP) database, a resolution system of procedure (R-MOP) database, and a change request (CR) database.

17. The storage medium of claim 15, wherein the instructions, when executed, further cause the at least one processor to, based on determining that an existing RCA does correspond to the error:
identify an existing resolution to the error based on the existing RCA; and
apply the existing resolution to the network to resolve the error.

18. The storage medium of claim 17, wherein the instructions, when executed, further cause the at least one processor to, based on the existing resolution not resolving the error, generate, by the knowledge-based AI model and using at least information regarding a failure of the existing resolution, a new resolution for resolving the error.

19. The storage medium of claim 15, wherein the instructions, when executed, further cause the at least one processor to:
determine whether a number of loops for the knowledge-based AI model exceeds a predetermined loop threshold; and
based on the number of loops not exceeding the predetermined loop threshold:
perform the identifying; and
apply the first resolution to the network to resolve the error.

20. The storage medium of claim 15, wherein the instructions, when executed, further cause the at least one processor to:
determine whether a number of loops for the knowledge-based AI in generating RCAs exceeds a predetermined loop threshold; and
based on the number of loops exceeding the predetermined loop threshold:
identify at least one abnormality with the knowledge-based AI model; and
update the knowledge-based AI model based on the identified abnormality.
